(19) United States
(12) Patent Application Publication
(10) Pub. No.: US 2015/0215429 A1
(43) Pub. Date: Jul. 30, 2015

(54) SYSTEM AND METHOD FOR EXTRACTING IDENTIFIERS FROM TRAFFIC OF AN UNKNOWN PROTOCOL

(71) Applicant: Verint Systems Ltd., Herzliya Pituach (IL)

(72) Inventors: Ofer Weisblum, Herzliya Pituach (IL); Jack Zeitune, Kfar Saba (IL); Sofia Zilberman, Herzliya Pituach (IL); Ruth Franco, Herzliya Pituach (IL)

(21) Appl. No.: 14/604,141

(22) Filed: Jan. 23, 2015

(30) Foreign Application Priority Data
Jan. 30, 2014 (IL) 230743

(51) Int. Cl. H04L 29/08; H04L 12/26

(52) U.S. Cl. CPC H04L 67/327; H04L 43/062; H04L 43/18

(57) ABSTRACT

Systems and methods for extracting identifiers from traffic of an unknown protocol are provided herein. An example method can include receiving communication traffic transferred over a communication network in accordance with a communication network. A data item that matches a predefined pattern can be identified in the communication traffic, irrespective of the communication protocol. The identified data item can then be extracted from the communication traffic.

### FIELD OF THE DISCLOSURE

The present disclosure relates generally to communication analysis, and particularly to methods and systems for extracting identifiers from communication traffic.

### BACKGROUND OF THE DISCLOSURE

Various systems and applications are used for exchanging data over communication networks, such as various cellular networks or the Internet. Such systems and applications may use various kinds of protocols, and may carry data of various media types, such as text, audio, still images or video.

Various methods and systems for analyzing data exchanged in communication traffic are known in the art. For example, U.S. Patent Application Publication 2011/0305141, whose disclosure is incorporated herein by reference, describes methods and systems for analyzing network traffic. An analysis system receives network traffic, which complies with a certain protocol. The received network traffic carries a data item, which may be of value to an analyst. In order to access the data item in question, the analysis system automatically identifies the media type of the data item, by processing the network traffic irrespective of the protocol. The analysis system identifies the media type irrespective of the protocol in order to avoid the computational complexity involved in decoding the protocol.

### SUMMARY OF THE DISCLOSURE

An embodiment that is described herein provides a method including receiving communication traffic, which is transferred over a communication network in accordance with a communication protocol. A data item that matches a predefined pattern is identified in the communication traffic, irrespective of the communication protocol. The identified data item is extracted from the communication traffic.

In some embodiments, identifying the data item includes applying to the communication traffic a regular expression that represents the predefined pattern. In an embodiment, the communication traffic includes at least a textual part, and identifying the data item includes detecting the data item in the textual part of the communication traffic.

In some embodiments, the data item includes an identifier of a user or a communication terminal associated with the communication traffic. In an example embodiment, the method includes extracting an additional identifier of the user or the communication terminal from metadata of the communication traffic, and correlating the identifier and the additional identifier.

In another embodiment, the data item includes location information of a communication terminal associated with the communication traffic. In an embodiment, the method includes training a decoding algorithm based on the extracted data item, to decode the communication protocol.

There is additionally provided, in accordance with an embodiment that is described herein, apparatus including an interface and a processor. The interface is configured to connect to a communication network and to receive communication traffic that is transferred over the communication network in accordance with a communication protocol. The processor is configured to identify in the communication traffic, irrespective of the communication protocol, a data item that matches a predefined pattern, and to extract the identified data item from the communication traffic.

The present disclosure will be more fully understood from the following detailed description of the embodiments thereof, taken together with the drawings in which:

### BRIEF DESCRIPTION OF THE DRAWINGS

FIG. 1 is a block diagram that schematically illustrates a system for analyzing network traffic, in accordance with an embodiment that is described herein; and

FIG. 2 is a flow chart schematically illustrates a method for extracting identifiers from network traffic, in accordance with an embodiment that is described herein.

### DETAILED DESCRIPTION OF EMBODIMENTS

### Overview

Embodiments that are described herein provide improved methods and systems for analyzing network traffic. In some embodiments, an analysis system analyzes traffic received from a communication network, such the Internet or a cellular network. The system extracts from the traffic data items of interest, e.g., e-mail addresses of users or location information of communication terminals. Typically, the system identifies data items of interest in the higher layers of the traffic (e.g., application layer), irrespective of the communication protocol or application used for sending the traffic.

In an example embodiment, the system searches over textual portions of the traffic for predefined patterns that are indicative of the data items in question, e.g., using regular expressions. For example, the system may search for the patterns “LAT:” and “LONG:” in order to find GPS coordinates embedded in the traffic, or search for the patterns “TO:” or “FROM:” in order to find e-mail addresses. Such patterns can be located by treating the traffic as a byte stream, without having to decode and parse the underlying communication protocol.

Upon extracting a data item, the system may correlate the data item with one or more identifiers that are extracted from metadata of the traffic, such as with an IP address or International Mobile Subscriber Identity (IMSI). Correlation of this sort is valuable, for example, for subsequent tracking of target users. Since the data items are extracted from the higher traffic layers without decoding the protocol, their exact meaning is not always fully verified. Thus, in some embodiments the system performs the correlation statistically, e.g., using graph-based techniques that give more weight to correlations that are found more frequently and ignore rare correlations.

In some embodiments, when searching for data items of interest, processor 36 also considers the direction of the communication. For example, in an incoming e-mail the “TO:” field is typically more valuable than the “FROM:” field, and vice versa.

Extraction of data items irrespective of protocol is advantageous for various reasons. In some cases, the protocol is unknown to the system or cannot be decoded by the system for other reasons. In other cases, the system may be capable of decoding the protocol, but uses the disclosed techniques in order to avoid the computational complexity involved in decoding the protocol.

### System Description

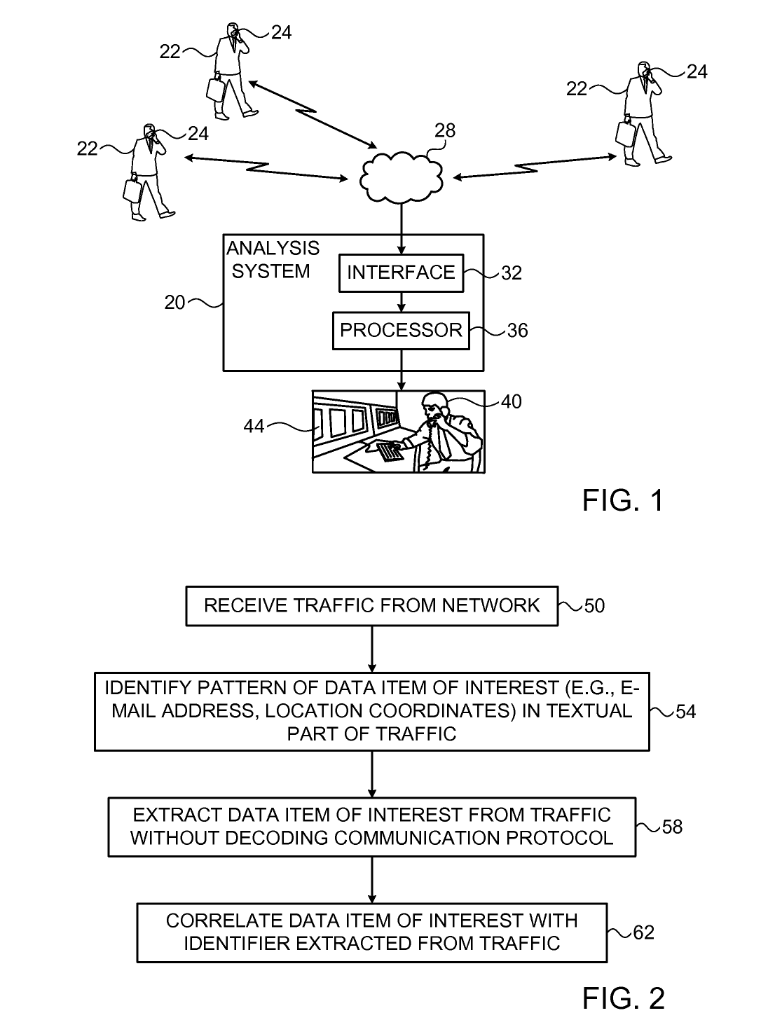

FIG. 1 is a block diagram that schematically illustrates a computerized system 20 for analyzing network traffic, in accordance with an embodiment that is described herein. System 20 is connected to a communication network 28, and receives from network 28 communication traffic that is exchanged between users 22 using communication terminals 24.

Network 28 may comprise, for example, a Wide-Area Network (WAN) such as the Internet, a cellular communication network, or any other suitable network type. Typically although not necessarily, network 28 comprises an Internet Protocol (IP) network and the communication traffic comprises communication packets. Communication terminals 24 may comprise, for example, personal or mobile computers, cellular phones, smartphones, Personal Digital Assistants (PDAs), or any other suitable type of communication or computing device having communication capabilities. Terminals 24 may communicate over network 28 using any suitable protocols.

System 20 receives communication traffic (e.g., communication packets) from network 28, and analyzes the traffic in order to extract information that is of value. In particular, system 20 extracts from the traffic data items of interest, without having to decode the underlying communication protocol. Example methods for extracting data items irrespective of communication protocol are described further below.

Systems of this sort can be used, for example, in test equipment, network probes, Quality-of-Service (QoS) systems, Digital Rights Management (DRM) systems, or in any other suitable system or application. System 20 may avoid decoding the protocol for various reasons. For example, in some cases the protocol is not known or not decodable. In other embodiments, system 20 eliminates the computational load associated with decoding the protocol.

In the example of FIG. 1, system 20 comprises a network interface 32 for receiving the traffic from network 28, and a processor 36 that carries out the methods described herein. The extracted data items, or any other suitable output of system 20, are presented to an operator 40 using a suitable output device, such as a display 44.

Interface 32 typically receives the desired network traffic passively, i.e., monitors traffic without transmitting, intervening, requesting traffic or otherwise affecting the network operation. Interface 32 may monitor any suitable element or interface in network 28, such as the air interface between terminals 24 and the network, or an interface between network elements (e.g., switches) of network 28.

The system configuration shown in FIG. 1 is an example configuration, which is chosen purely for the sake of conceptual clarity. In alternative embodiments, any other suitable system configuration can also be used. For example, the functions of system 20 can be integrated with other analysis functions. Certain elements of system 20 can be implemented using hardware, such as using one or more Application-Specific Integrated Circuits (ASICs) or Field-Programmable Gate Arrays (FPGAs). Additionally or alternatively, certain elements of system 20 can be implemented using software, or using a combination of hardware and software elements.

Typically, processor 36 comprises a general-purpose computer, which is programmed in software to carry out the functions described herein. The software may be downloaded to the computer in electronic form, over a network, for example, or it may, alternatively or additionally, be provided and/or stored on non-transitory tangible media, such as magnetic, optical, or electronic memory.

### Identifier Extraction from Traffic of an Unknown Protocol

Users 22 of terminals 24 communicate over network 28 using various protocols. Example protocols are various proprietary protocols used by peer-to-peer applications (e.g., eMule or BitTorent), gaming applications and chat applications. Other example protocols are the Hyper-Text Transfer Protocol (HTTP), File Transfer Protocol (FTP), Real Time Protocol (RTP), Transmission Control Protocol (TCP) or User Datagram Protocol (UDP).

The protocol may comprise an application-layer protocol, i.e., a protocol that is associated with layer 7 of the Open System Interconnection (OSI) reference model. Example application-layer protocols comprise HTTP, FTP and RTP, among others. In alternative embodiments, the protocol is associated with some layer that is higher than the transport layer, i.e., higher than layer 4 of the OSI model. The disclosed techniques can be used to analyze traffic that uses any of the protocols listed above, variants of these protocols, or any other suitable protocol.

In many practical cases, it is desirable or necessary for system 20 to extract data from network traffic without decoding or parsing the underlying protocol. For example, the exact structure of the protocol may not be known to the system, in which case the system is unable to decode the protocol. In other cases, the system avoids decoding the protocol in order to avoid the associated computational complexity or latency. In yet other cases, the system may refrain from decoding the protocol for any other reason.

FIG. 2 is a flow chart schematically illustrates a method for extracting identifiers from network traffic, in accordance with an embodiment that is described herein. The method begins with system 20 receiving traffic (e.g., packets) from network 28 using interface 32, at a reception step 50.

Processor 36 of system 20 identifies in the traffic one or more predefined patterns that are indicative of respective data items of interest, at a pattern identification step 54. This identification is performed irrespective of the underlying protocol, i.e., without fully decoding or parsing the protocol.

The data items of interest may comprise, for example, identifiers of a user or of a communication terminal associated with the traffic, a location (e.g., GPS coordinates) reported by a terminal associated with the traffic, or any other suitable type of data item.

For example, occurrences of strings such as “TO:”, “FROM:” or “CC:” in the traffic are typically followed by an e-mail address. Occurrence of a string such as “USERNAME:” is typically followed by a user name. As another example, occurrences of strings such as “LAT:” or “LONG:” are likely to be followed by GPS coordinates of the terminal sending the traffic. An e-mail address can be detected by matching to a suitable regular expression, e.g., an expression that comprises up to X alphanumeric characters (plus additional permitted characters such as “.” “-” or “_”) followed by a ‘@’ and then another set of alphanumeric characters that ends with one of a predefined set of suffixes such as “.com”, “.edu” or “.gov”. Suitable regular expressions can also be used for identifying data items such as telephone numbers, credit card numbers, IP addresses, domain names, and many others. Further alternatively, processor 36 may search for any other suitable patterns that are indicative of any other suitable data items of interest.

Processor 36 typically holds a definition of predefined patterns to be identified in the traffic. The patterns may be defined, for example, using exact strings, using regular expressions, or in any other suitable way. Processor 36 typically applies the predefined patterns to the received traffic.

In some embodiments, processor 36 distinguishes between textual portions of the traffic and other portions of the traffic (e.g., portions containing metadata, video or other non-textual information). The processor then searches for occurrences of the patterns in the textual portions only.

Upon identifying a match to a given pattern, processor 36 extracts the corresponding data item of interest, at a data item extraction step 58. The extraction is again performed irrespective of the underlying protocol, i.e., without fully decoding or parsing the protocol. In some embodiments, the extracted data items are reported to operator 40, possibly together with other information regarding the traffic in which they were found.

In some embodiments, processor 36 may also extract and reports a ‘snippet’ (a small excerpt of the traffic) around the identified data item. The snippet enables operator 40 (typically an analyst) to examine the context of the data item. For example, a human reader can easily understand whether an e-mail address was mentioned as part of a text or as a metadata of a protocol by looking at the surrounding text.

In some embodiments, processor 36 correlates the data item of interest with an identifier that is extracted from the metadata of the traffic, at a correlation step 62. For example, processor 36 may extract from the traffic metadata an IP or Medium Access Control (MAC) address of the terminal sending or receiving the traffic. As another example, the processor may extract from the metadata an International Mobile Subscriber Identity (IMSI), an International Mobile Equipment Identity (IMEI), a Temporary Mobile Subscriber Identity (TMSI) or a Mobile Station International Subscriber Directory Number (MSISDN) of the terminal sending or receiving the traffic.

As yet another example, processor 36 may correlate the terminal identifier with one or more GTP tunnel identifiers used between the SGSN and GGSN in the mobile operator network.

Further alternatively, processor 36 may extract from the metadata any other suitable identifier and correlate it with a data item extracted from the textual portion of the traffic. Processor 36 typically reports the correlation to operator 40. Using this technique, system 20 may establish, for example, a correlation between the IP address of a terminal and an e-mail address of a user. This sort of correlation is valuable for subsequent tracking this user.

Additionally or alternatively, processor 36 may correlate user and/or terminal identifiers that are all extracted from the textual portion of the traffic at step 58 above. For example, processor 36 may establish a correlation between an e-mail address of a user and GPS coordinates of a terminal. Further alternatively, various other kinds of correlations can be established using the disclosed techniques.

In some embodiments, processor 36 may use the identification of data items at step 54 above for learning the structure of the underlying communication protocol. For example, processor 36 may report the locations in the traffic in which a given pattern was found, other characteristic patterns found in the same vicinity, or any other suitable information. This information can be used, either by processor 36, by operator 40 or by some external system, for training an algorithm (e.g., a template) that decodes the protocol.

The principles of the present disclosure can be used in various other systems and applications. For example, Data Leakage Prevention (DLP) systems may use the disclosed techniques to identify sensitive information such as phone numbers, Social Security numbers or credit card numbers, regardless of the underlying protocol. Cyber security systems may use the disclosed techniques, as well.

It will thus be appreciated that the embodiments described above are cited by way of example, and that the present disclosure is not limited to what has been particularly shown and described hereinabove. Rather, the scope of the present disclosure includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A method, comprising:
receiving communication traffic, which is transferred over a communication network in accordance with a communication protocol;
identifying in the communication traffic, irrespective of the communication protocol, a data item that matches a predefined pattern; and
extracting the identified data item from the communication traffic.

2. The method according to claim 1, wherein identifying the data item comprises applying to the communication traffic a regular expression that represents the predefined pattern.

3. The method according to claim 1, wherein the communication traffic comprises at least a textual part, and wherein identifying the data item comprises detecting the data item in the textual part of the communication traffic.

4. The method according to claim 1, wherein the data item comprises an identifier of a user or a communication terminal associated with the communication traffic.

5. The method according to claim 4, and comprising extracting an additional identifier of the user or the communication terminal from metadata of the communication traffic, and correlating the identifier and the additional identifier.

6. The method according to claim 1, wherein the data item comprises location information of a communication terminal associated with the communication traffic.

7. The method according to claim 1, and comprising training a decoding algorithm based on the extracted data item, to decode the communication protocol.

8. Apparatus, comprising:
an interface, which is configured to connect to a communication network and to receive communication traffic that is transferred over the communication network in accordance with a communication protocol; and
a processor, which is configured to identify in the communication traffic, irrespective of the communication protocol, a data item that matches a predefined pattern, and to extract the identified data item from the communication traffic.

9. The apparatus according to claim 8, wherein the processor is configured to identify the data item by applying to the communication traffic a regular expression that represents the predefined pattern.

10. The apparatus according to claim 8, wherein the communication traffic comprises at least a textual part, and wherein the processor is configured to identify the data item in the textual part of the communication traffic.

11. The apparatus according to claim 8, wherein the data item comprises an identifier of a user or a communication terminal associated with the communication traffic.

12. The apparatus according to claim 11, wherein the processor is configured to extract an additional identifier of the user or the communication terminal from metadata of the communication traffic, and to correlate the identifier and the additional identifier.

13. The apparatus according to claim 8, wherein the data item comprises location information of a communication terminal associated with the communication traffic.

14. The apparatus according to claim 8, wherein the processor is configured to train a decoding algorithm based on the extracted data item, to decode the communication protocol.

15. A non-transitory computer readable medium having instructions stored thereon that, when executed by a computer, direct the computer to:
receive communication traffic, which is transferred over a communication network in accordance with a communication protocol;
identify in the communication traffic, irrespective of the communication protocol, a data item that matches a predefined pattern; and
extract the identified data item from the communication traffic.

16. The non-transitory computer readable medium of claim 15, wherein identifying the data item comprises applying to the communication traffic a regular expression that represents the predefined pattern.

17. The non-transitory computer readable medium of claim 15, wherein the communication traffic comprises at least a textual part, and wherein identifying the data item comprises detecting the data item in the textual part of the communication traffic.

18. The non-transitory computer readable medium of claim 15, wherein the data item comprises an identifier of a user or a communication terminal associated with the communication traffic, and wherein the instructions, when executed by the computer, further direct the computer to:
extract an additional identifier of the user or the communication terminal from metadata of the communication traffic; and
correlate the identifier and the additional identifier.

19. The non-transitory computer readable medium of claim 15, wherein the data item comprises location information of a communication terminal associated with the communication traffic.

20. The non-transitory computer readable medium of claim 15, wherein the instructions, when executed by the computer, further direct the computer to train a decoding algorithm based on the extracted data item to decode the communication protocol.
